(19) United States
(12) Patent Application Publication
(10) Pub. No.: US 2005/0287380 A1
(43) Pub. Date: Dec. 29, 2005

(54) Adhesion-promoting polyester film comprising poly(m-xyleneadipamide)

(76) Inventors: Oliver Klein, Mainz (DE); Herbert Peiffer, Mainz (DE)

Correspondence Address: PROPAT, L.L.C., 425-C SOUTH SHARON AMITY ROAD, CHARLOTTE, NC, 28211-2841, US

(21) Appl. No.: 11/152,533

(22) Filed: Jun. 14, 2005

(30) Foreign Application Priority Data
Jun. 26, 2004 (DE) 10 2004 030 978.7

(51) Int. Cl. B32B 27/36

(52) U.S. Cl. 428/480; 428/910; 525/425

(57) ABSTRACT

Polyester films which comprise not only thermoplastic polyester, e.g. polyethylene terephthalate, but also from 5 to 45% by weight of poly(m-xyleneadipamide) and optionally from 0.02 to 1% by weight of fillers. The inventive films have at least one adhesion-promoting surface and are produced by a sequential stretching process. The inventive films feature improved mechanical properties, such as a modulus of elasticity greater than 3500 N/mm² in both orientation directions, high gloss, low haze, and very good barrier properties with respect to oxygen transmission. The inventive films are therefore suitable as packaging material for foods and other consumable items.

### CROSS-REFERENCE TO RELATED APPLICATIONS

This application claims priority to German parent application 10 2004 030 978.7, which is hereby incorporated by reference in its entirety.

### FIELD OF THE INVENTION

The invention relates to a transparent, biaxially oriented polyester film which comprises polyester and poly(m-xyleneadipamide), and which has been modified so as to be adhesion-promoting on at least one side. The inventive film has at least one surface which has good adhesion to other layers composed of polymer or of metal, or to printing inks. The invention also relates to a process for the production of the film and to its use.

### BACKGROUND OF THE INVENTION

Transparent, biaxially oriented polyester films which feature improved barrier properties are known from the prior art. In most instances, the films obtain their improved barrier properties off-line downstream of the production process via a further step in processing. Examples here are extrusion coating, coating or lamination with barrier materials, in-vacuo coating with metals or with ceramic substances, or plasma polymerization combined with vacuum coating.

An exception here is the process described in more detail in WO 99/62694, in which a multilayer, coextruded polyester film which comprises at least one layer comprised of EVOH (ethylene-vinyl alcohol) is simultaneously biaxially oriented. This film features good mechanical properties, but in particular features good barrier properties with respect to oxygen transmission. The best achievable value for oxygen transmission OTR (oxygen transmission rate) is given in the specification as 5 cm³/(m²·bar·d). A disadvantage of the process is, inter alia, that the regrind produced during the production process cannot be reintroduced into the production process without sacrificing the good optical and physical properties of the film.

Another exception is the film of EP-A-0 675 158, which is a stretched composite film based on polyester with improved barrier properties with respect to gases. The film has been coated at least on one of the two sides with a layer of thickness 0.3 μm or less comprised of polyvinyl alcohol whose number-average degree of polymerization is 350 or more, the average roughness R_{Z} of the side to be coated of the base film being 0.30 μm or less, and this side being characterized by a certain distribution of the elevations on the film surface. The oxygen transmission of this composite film is less than 3 cm³/(m²·bar·d). A disadvantage of this composite film is its low resistance, for example with respect to moisture. On contact with water or water vapor, the adhesion of the barrier coating comprised of polyvinyl alcohol to the polyester film is lost with the result that the barrier coating can be washed off the polyester film.

Another exception is the biaxially oriented film described in JP 2001-001399, which is comprised of a mixture of polyethylene terephthalate and poly(m-xyleneadipamide) (MXD6). The proportion of poly(m-xyleneadipamide) (MXD6) in the film is from 10 to 40% by weight, and the corresponding proportion of polyethylene terephthalate is from 60 to 90% by weight. According to the invention, the film is simultaneously biaxially oriented. The specification gives the following data for the stretching parameters:

The stretching ratios in both directions are from 2.5 to 5.0. However, in the examples the film is only oriented by a factor of 3.0 in the machine direction and by a factor of 3.3 transversely to the machine direction. The overall stretching ratio is therefore 9.9. The stretching temperatures in both directions are from 80 to 140° C. In the examples, the film is stretched in both directions at 90° C.

According to JP 2001-001399, when a simultaneously oriented film is compared with a sequentially oriented film (e.g. oriented first in machine direction (MD or MDO) and then in the transverse direction (TD or TDO)), it has lower haze and gives more dependable processing, i.e. can be produced with a smaller number of break-offs in the second stretching phase (e.g. in the transverse direction). According to the above specification, the degree of crystallization that occurs during the sequential (non-inventive) orientation in the first stretching step (e.g. MDO) is so great that the film becomes cloudy during the second (subsequent) orientation process and becomes more delicate with respect to any further orientation process. According to the (comparative) Examples 3 and 4 set out in the specification, a polyester film with from 10 to 40% of MXD6 cannot be produced by the sequential process, because it tears in the second stretching phase.

The biaxially oriented films produced according to JP 2001-001399 by the simultaneous process feature low haze, but in particular feature good barrier action with regard to oxygen permeation. The film achieves an oxygen transmission OTR smaller than 30 cm³/(m²·bar·d). According to the invention, the haze of the film is smaller than 15%. However, the film has a number of disadvantages:

It has a comparatively low mechanical strength. In particular, the modulus of elasticity and the ultimate tensile strength are unsatisfactory.

It tends to block and is therefore difficult to wind.

It has comparatively rough surfaces. The film also has a matt appearance, undesirable for many applications. It is therefore also comparatively difficult to print, to metallize, or to coat.

### SUMMARY OF THE INVENTION

It was an object of the present invention to provide a biaxially oriented polyester film which features very good barrier properties, in particular with respect to oxygen transmission. The film should moreover have the following advantageous properties/combinations of properties when compared with films of the prior art: higher mechanical strength, in particular a higher modulus of elasticity, high gloss and therefore good printability, good metallizability, and good coatability, good windability (without blocking) and capability for processing to give a customer roll without winding defects, capability for cost-effective production; by way of example this means that conventional stretching processes which can operate at high speed, e.g. above 350 m/min (above 400 m/min) can be used for industrial production of the film; there should be no need to use the expensive simultaneous stretching process which, according to the prior art, operates at markedly lower speed (<350 m/min) and width (<5 m) and is therefore less cost-effective, an amount which is preferably from 5 up to 60% by weight of the regrind produced during production of the film should be capable of reintroduction into the production process (extrusion and biaxial orientation) without any resultant significant adverse effect on the physical and optical properties of the film, but in particular on the barrier properties with respect to oxygen. The film should have at least one side which provides or promotes good adhesion, for example to other polymer layers or to other metal layers, or to printing inks.

### BRIEF DESCRIPTION OF THE DRAWINGS

FIG. 1 is a cross-sectional schematic illustration of an exemplary single layer film in accordance with the invention;

FIG. 2 is a cross-sectional schematic illustration of an exemplary three layer film in accordance with the invention;

FIG. 3 is a schematic illustration of an exemplary single gap stretching process in accordance with the invention; and

FIG. 4 is a schematic illustration of an exemplary two-stage stretching process in accordance with the invention.

### DETAILED DESCRIPTION OF THE INVENTION

The object is achieved via a biaxially oriented and transparent polyester film which is preferably produced by the sequential stretching process and which comprises poly(m-xyleneadipamide) (MXD6) at a concentration which is preferably 5 to 45% by weight, and which has a modulus of elasticity of at least 3500 N/mm² in both orientation directions (MD and TD), and at least one side of which has an adhesion-promoting layer or surface.

The film preferably comprises fillers, preferably at a concentration of from 0.02 to 1% by weight.

The film moreover comprises a thermoplastic polyester, its amount preferably being at least 55% by weight. The proportion of poly(m-xyleneadipamide) in the film is preferably from 5 to 45% by weight, in particular from 5 to 40% by weight. Unless otherwise stated, all % by weight data are based on the total weight of the inventive film.

Poly(m-xyleneadipamide) (MXD6), also termed poly-m-xylyleneadipamide or PA-MXD6, is a polycondensate (polarylamide) comprised of m-xylylenediamine and adipic acid, and is marketed in various grades, all of which are in principle suitable for the inventive purpose. However, preference is given to grades whose melt viscosity is smaller than 6000 poise (=600 Pa·s, T=280° C., shear rate γₚₒᵢₙₜ≧100 s⁻¹).

The biaxially oriented, transparent polyester film of the present invention has improved mechanical and improved optical properties when compared with films of the prior art, and in particular also has increased gloss. The film moreover features excellent barrier properties, in particular with respect to transmission of gases, such as oxygen.

The oxygen transmission rate (OTR) of the film is preferably smaller than 45 cm³/(m²·d·bar), preferably smaller than 40 cm³/(m²·d·bar), and particularly preferably smaller than 30 cm³/(m²·d·bar); based on a film of thickness 12 μm.

The film also exhibits the desired processing performance and desired winding performance. In particular, it exhibits no tendency to adhere to rollers or to other mechanical parts, no blocking problems, and no longitudinal corrugations on winding. The film therefore readily permits production of a saleable roll with very good quality of winding.

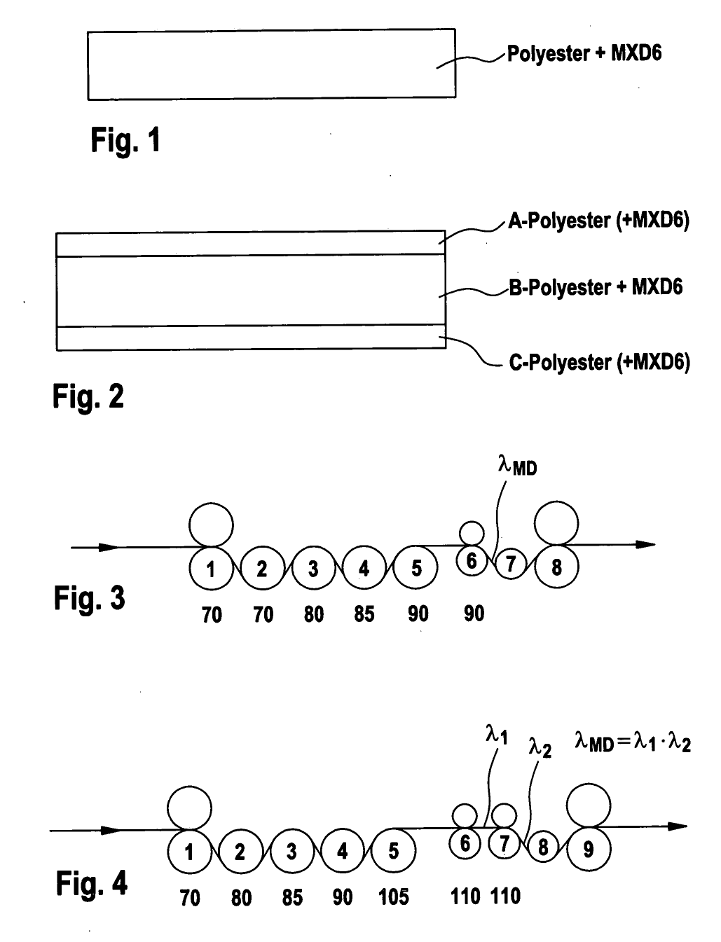

The film of the present invention is preferably comprised of the inventive polymer mixture. In this case, the film has a single-layer structure (cf. FIG. 1). In another inventive embodiment, the film has a multilayer structure, for example a three-layer structure (cf. FIG. 2). It is then comprised, by way of example, of the inventive base layer (B), of the outer layer (A) applied on one side of the base layer (B), and also of the outer layer (C) applied on the other side of the base layer (B). The layers (A) and (C) may be identical or different.

The film, or the base layer of the film, is preferably comprised of at least 55% by weight of thermoplastic polyester (=component I). Examples of materials suitable for this are polyesters comprised of ethylene glycol and terephthalic acid (=polyethylene terephthalate, PET), ethylene glycol and naphthalene-2,6-dicarboxylic acid (=polyethylene 2,6-naphthalate, PEN), 1,4-bishydroxymethylcyclohexane and terephthalic acid (=poly-1,4-cyclohexanedimethylene terephthalate, PCDT), or else made from ethylene glycol, naphthalene-2,6-dicarboxylic acid and biphenyl-4,4′-dicarboxylic acid (=polyethylene 2,6-naphthalate bibenzoate, PENBB). Preference is given to polyesters comprised of at least 90 mol %, in particular at least 95 mol %, of ethylene glycol units and terephthalic acid units, or of ethylene glycol units and naphthalene-2,6-dicarboxylic acid units. The remaining monomer units derive from other diols and other dicarboxylic acids. For component I of the film, or of the base layer (B), it is also advantageously possible to use copolymers or mixtures or blends comprised of the homo- and/or copolymers mentioned.

For the last-mentioned case it is particularly advantageous for the component I used in the film or in the base layer (B) to comprise a polyester copolymer based on isophthalic acid and terephthalic acid or based on terephthalic acid and naphthalene-2,6-dicarboxylic acid. In this case, the film is easy to produce and the optical properties of the film are particularly good, as also are the barrier properties achieved in the film. One particular advantage is that if, for example, a polyester copolymer based on isophthalic acid and terephthalic acid is used the extrusion temperature can be lowered, and this is particularly advantageous for processing of the MXD6. If, by way of example, 280° C. is required for the extrusion of polyethylene terephthalate, the extrusion temperature can be lowered to below 260° C. if a polyester copolymer based on isophthalic acid and terephthalic acid is used. The MXD6 then remains ductile for the stretching phase that follows, and this is discernible, by way of example, in high process stability and in very good mechanical properties.

In this case, component I of the film or of the base layer (B) of the film in essence comprises a polyester copolymer comprised predominantly of isophthalic acid units and of terephthalic acid units and of ethylene glycol units, and component II of the film comprises in essence the abovementioned inventive poly(m-xyleneadipamide) (MXD6). However, mixtures comprised of polyethylene terephthalate and polyethylene isophthalate are also preferred as component I.

The preferred copolyesters (component I), which provide the desired properties of the film (in particular the optical properties, together with orientability) are those comprised of terephthalate units and of isophthalic units, and of ethylene glycol units. The proportion of ethylene terephthalate in these copolymers is preferably from 70 to 98 mol %, and the corresponding proportion of ethylene isophthalate is from 30 to 2 mol %. Among these, preference is in turn given to those copolyesters in which the proportion of ethylene terephthalate is from 76 to 98 mol %, and the corresponding proportion of ethylene isophthalate is from 24 to 2 mol %, and very particular preference is given to those copolyesters in which the proportion of ethylene terephthalate is from 80 to 98 mol % and the corresponding proportion of ethylene isophthalate is from 20 to 2 mol %.

Examples of other suitable aliphatic diols which may be constituents of the inventive polyesters are diethylene glycol, triethylene glycol, aliphatic glycols of the formula HO—(CH₂)ₙ—OH, where n is an integer from 2 to 6 (in particular 1,3-propanediol, 1,4-butanediol, 1,5-pentanediol and 1,6-hexanediol) or branched aliphatic glycols having up to 6 carbon atoms, and cycloaliphatic diols having one or more rings and, if appropriate, containing heteroatoms. Among the cycloaliphatic diols, mention should be made of cyclohexanediols (in particular 1,4-cyclohexanediol). Examples of suitable other aromatic diols have the formula HO—C₆H₄—X—C₆H₄—OH, where X is —CH₂—, —C(CH₃)₂—, —C(CF₃)₂—, —O—, —S— or —SO₂—. Bisphenols of the formula HO—C₆H₄—C₆H₄—OH are also very suitable.

Suitable other aromatic dicarboxylic acids which may be constituents of the inventive polyesters are preferably benzenedicarboxylic acids, naphthalene dicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid) or stilbene-x,x′-dicarboxylic acids. Among the cycloaliphatic dicarboxylic acids mention should be made of cyclohexanedicarboxylic acids (in particular cyclohexane-1,4-dicarboxylic acid). Among the aliphatic dicarboxylic acids, the (C₃-C₁₉) alkanediacids are particularly suitable, and the alkane moiety here may be straight-chain or branched.

One way of preparing the polyesters is the known transesterification process. Here, the starting materials are dicarboxylic esters and diols, which are reacted using the customary transesterification catalysts, such as the salts of zinc, of calcium, of lithium or of manganese. The intermediates are then polycondensed in the presence of well known polycondensation catalysts, such as antimony trioxide or titanium salts. Another equally good preparation method is the direct esterification process in the presence of polycondensation catalysts. This starts directly from the dicarboxylic acids and the diols. The inventive polyesters are moreover obtainable from various producers.

According to the invention, the base layer (B) or the film comprises an amount of in particular from 5 to 40% by weight and particularly preferably from 5 to 35% by weight of poly(m-xyleneadipamide) (MXD6) (=component II) as another component.

For the processing of the polymers it has proven advantageous for the poly(m-xyleneadipamide) (MXD6) to be selected in such a way that the viscosities of the respective polymer melts do not differ excessively. Otherwise, additional elevations/protrusions, flow disruption, or streaking on the finished film can sometimes be expected. Furthermore, the polymers then tend to separate. In accordance with the experiments carried out here, the melt viscosity of the poly(m-xyleneadipamide) (MXD6) should preferably be below certain values. For the purposes of the present invention, very good results are obtained if the melt viscosity of the MXD6 is smaller than 6000 poise (measured in a capillary rheometer of diameter 0.1 mm, of length 10 mm, and with a shear rate of γₚₒᵢₙₜ≧100 s-¹, melt temperature 280° C.), preferably smaller than 5000 poise, and particularly preferably smaller than 4000 poise.

Similar factors also apply to the viscosity of the polyester used. For the purposes of the present invention, very good results are obtained if the melt viscosity of the polyester is smaller than 2400 poise (measured in a capillary rheometer of diameter 0.1 mm, of length 10 mm, and with a shear rate of γₚₒᵢₙₜ≧100 s-¹, melt temperature 280° C.), preferably smaller than 2200 poise, and particularly preferably smaller than 2000 poise.

The form in which the poly(m-xyleneadipamide) (MXD6) is incorporated into the film is advantageously either that of pure pelletized material or that of pelletized concentrate (masterbatch). In the case of processing by way of a masterbatch, its concentration is preferably from 10 to 60% by weight of MXD6. To this end, the pelletized polyester is premixed with the poly(m-xyleneadipamide) (MXD6) or with the poly(m-xyleneadipamide) (MXD6) masterbatch, and then introduced into the extruder. In the extruder, the components are further mixed and heated to processing temperature. It is advantageous here for the inventive process if the extrusion temperature is above the melting point T_{M} of the poly(m-xyleneadipamide) (MXD6), generally above the melting point of the poly(m-xyleneadipamide) (MXD6) by at least 5° C., preferably by from 5 to 50° C., in particular however by from 5 to 40° C. A twin-screw extruder is clearly a preferred extrusion unit for the processing of the mixture, and also for the preparation of the masterbatch from components I and II. Another factor which should be mentioned is that good results are achieved even with a single-screw extruder, and therefore that this principle is generally applicable.

The film of the present invention has at least a single-layer structure. It is then comprised of the inventive mixture, preferably produced by the inventive process. The film can moreover have additional layers, e.g. an outer layer (C) arranged on the base layer (B), or else intermediate layers, e.g. between the base layer (B) and the outer layer (C). Typical film structures are then, by way of example, B (=monofilm), or BC, or BZC, where (Z) is an intermediate layer and (C) is an outer layer, or else ABC or ABA, where the outer layers A and C may be identical or different.

The polymers used for the outer layer and for the intermediate layers may in principle be identical with those used for the base layer B. However, other materials may also be present in these outer layers, and these layers are then preferably comprised of a mixture of polymers, of copolymers, or of homopolymers, preferably containing ethylene isophthalate units and/or ethylene 2,6-naphthalate units, and/or ethylene terephthalate units. Up to 10 mol % of the polymers may be comprised of other comonomers.

(Polyester) copolymers, or (polyester) mixtures, or blends comprised of homo- and/or copolymers may also be used advantageously as another component in these other layers.

It is particularly advantageous to use a polyester copolymer based on isophthalic acid and terephthalic acid in the outer layer (C) and/or (A). In this case, the optical properties of the film as particularly good.

In this case, the outer layer (C) and/or (A) of the film in essence comprises a polyester copolymer comprised mainly of isophthalic acid units and of terephthalic acid units, and of ethylene glycol units. The remaining monomer units derive from other aliphatic, cycloaliphatic, or aromatic diols and, respectively, other dicarboxylic acids, these being those which may also occur in the base layer. The preferred copolyesters which provide the desired properties of the film (in particular the optical properties) are those whose structure is comprised of terephthalate units and of isophthalate units, and of ethylene glycol units. The proportion of ethylene terephthalate is preferably from 40 to 97 mol %, the corresponding proportion of ethylene isophthalate being from 60 to 3 mol %. Preference is given to copolyesters in which the proportion of ethylene terephthalate is from 50 to 90 mol % and the corresponding proportion of ethylene isophthalate is from 50 to 10 mol %, and high preference is given to copolyesters in which the proportion of ethylene terephthalate is from 60 to 85 mol % and the corresponding proportion of ethylene isophthalate is from 40 to 15 mol %.

In another embodiment, the outer layer (C) and/or (A) comprises, as another component, an amount which is preferably from 0 to 80% by weight, in particular from 2 to 60% by weight, and particularly preferably from 4 to 40% by weight, of poly(m-xyleneadipamide) (MXD6) (=component II), based on the weight of the respective outer layer.

The thickness of the outer layers is preferably greater than 0.5 μm, and is preferably in the range from 1.0 to 20 μm, and particularly preferably in the range from 1.5 to 10 μm.

The base layer (B), and also any outer and intermediate layers present, may also comprise conventional additives, e.g. stabilizers and antiblocking agents. They are advantageously added to the polymer or polymer mixture before the melting process begins. Examples of stabilizers used are phosphorus compounds, such as phosphoric acid or phosphoric esters.

Typical antiblocking agents (in this context also termed pigments or fillers) are inorganic and/or organic particles, such as calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, the calcium, barium, zinc, or manganese salts of the dicarboxylic acids used, carbon black, titanium dioxide, kaolin, crosslinked polystyrene particles, or crosslinked acrylate particles.

Other additives which may be selected are mixtures of two or more different antiblocking agents or mixtures of antiblocking agents of identical constitution but different particle size. The conventional concentrations of the particles may be added, e.g. in the form of a glycolic dispersion during the polycondensation process, or by way of masterbatches during the extrusion process, to the individual layers, or else they may be added directly into the extruder in the form of “direct additive addition” [DAA] during the extrusion process).

According to the invention, the film comprises a concentration of fillers which is preferably from 0.02 to 1% by weight, preferably from 0.04 to 0.8% by weight, and particularly preferably from 0.06 to 0.6% by weight, based on the weight of the film. (EP-A-0 602 964 gives by way of example a detailed description of suitable fillers or suitable antiblocking agents.)

If the filler concentration is less than 0.02% by weight, the film can block and then, by way of example, can no longer be wound. If the filler concentration is, in contrast, more than 1.0% by weight, the film sometimes loses its high transparency and becomes cloudy. It can then no longer be used as a packaging film, for example.

In one preferred embodiment of the invention, the proportion of filler in the outer layers (A and/or C) is less than 0.6% by weight, preferably less than 0.5% by weight, and particularly preferably less than 0.4% by weight, based on the weight of the respective outer layer.

According to the invention, at least one film surface has been treated in such a way that the contact angle with respect to water is preferably <64°, in particular <62°, particularly preferably <60°.

This is preferably achieved via corona- or flame-treatment of the film surface (Softal, Hamburg), and this usually follows the heat-setting of the film. The treatment can likewise take place at other locations in the film production process, for example upstream of or downstream of the longitudinal stretching process.

As an alternative to, or in addition to the surface treatment described above, at least one of the surfaces of the film may be coated with a functional coating in such a way that the thickness of the coating on the finished film is preferably from 5 to 2000 nm, preferably from 20 to 500 nm, in particular from 30 to 200 nm. The coating is preferably applied in-line, i.e. during the film production process, advantageously upstream of the transverse stretching process. It is particularly preferable to apply the material by means of the reverse gravure-roll coating process, which can apply the coating extremely homogeneously in layer thicknesses up to about 200 nm. Application via the Meyer rod process is also preferred and can achieve relatively high coating thicknesses. The coatings are preferably applied in the form of solutions, suspensions, or dispersions, particularly preferably in the form of an aqueous solution, suspension, or dispersion.

The coatings mentioned give the film surface an additional function; by way of example, the film thus becomes sealable, printable, metallizable, sterilizable, or antistatic, or the coatings improve, by way of example, the aroma barrier, or permit adhesion to materials which would not otherwise adhere to the film surface.

Examples of substances/compositions which give additional functionality are: acrylates, as described by way of example in WO 94/13476, ethylene-vinyl alcohols, PVDC, waterglass (Na₂SiO₄), hydrophilic polyesters (PET/IPA polyesters containing the sodium salt of 5-sulfoisophthalic acid, these being described by way of example in EP-A-0 144 878, U.S. Pat. No. 4,252,885 or EP-A-0 296 620), polyvinyl acetates, for example those described in WO 94/13481, polyurethanes, the alkali metal or alkaline earth metal salts of C₁₀-C₁₈ fatty acids, butadiene copolymers with acrylonitrile or methyl methacrylate, methacrylic acid, or esters thereof.

The substances/compositions mentioned are applied, by way of example, in the form of dilute solution, emulsion, or dispersion, preferably in the form of an aqueous solution, emulsion, or dispersion, to one or both film surfaces, and the solvent is then volatilized. If the coatings are applied in-line upstream of the transverse stretching process, the heat treatment in the transverse stretching process is usually sufficient to volatilize the solvent and to dry the coating.

In one preferred embodiment of the invention, a copolyester coating is used to achieve the improved adhesion. The preferred coating copolyesters are prepared via polycondensation of a) isophthalic acid, b) an aliphatic dicarboxylic acid having the formula
HOOC(CH₂)ₙCOOH,
where n is in the range from 1 to 11, c) a sulfo monomer containing an alkali metal sulfonate group on the aromatic moiety of an aromatic dicarboxylic acid, and d) at least one aliphatic or cycloaliphatic alkylene glycol having about 2-11, preferably 2-8, particularly preferably 2-6, carbon atoms. The total number of acid equivalents present are to be in essence the same in molar terms as the total number of glycol equivalents present.

It has been found that the relative proportions of components a) to d) used to prepare the preferred copolyester coatings are important for the achievement of a coated film with satisfactory adhesion. By way of example, at least about 65 mol % of isophthalic acid (component a) should be present as acid component. Component a) is preferably pure isophthalic acid, its amount present being about 70-95 mol %. The rule for component b) is that satisfactory results are obtained with any acid of the formula mentioned, but preference is given to adipic acid, azelaic acid, sebacic acid, malonic acid, succinic acid, glutaric acid, or a mixture of these acids. The desirable amount within the range stated is preferably from 1 to 20 mol %, based on the acid components of the copolyester, if component b) is present in the composition. The amount present in this system of the monomers forming component c) of the preferred copolyester coating should preferably be at least 5 mol %, so that the coating becomes water-dispersible. The amount of monomer of component c) is particularly preferably about 6.5-12 mol %. The amount present of the glycol component d) is approximately stoichiometric.

In another preferred embodiment of the invention, an acrylate coating is used to achieve the improved adhesion. The acrylic copolymers preferably used are preferably comprised in essence of at least 50% by weight of one or more polymerized acrylic and/or methacrylic monomers and about 1-15% by weight of a copolymerizable comonomer which in the copolymerized state is capable of intermolecular crosslinking on exposure to an elevated temperature, if appropriate without addition of any separate resin-like crosslinking agent.

The amount present of the acrylic component of the adhesion-promoter copolymers is preferably from 50 to 99% by weight, and this component is preferably comprised of an ester of methacrylic acid, in particular of an alkyl ester whose alkyl group contains up to ten carbon atoms, examples being the methyl, ethyl, n-propyl, isopropyl, n-butyl, isobutyl, tert-butyl, hexyl, 2-ethylhexyl, heptyl, and n-octyl group. Acrylic copolymers which derive from a lower alkyl acrylate (C1-C4), in particular ethyl acrylate, give particularly good adhesion between the polyester roll and reprographic coatings and matt coatings applied thereto if they are used together with a lower alkyl methacrylate. It is very particularly preferable to use adhesion-promoter copolymers comprised of an alkyl acrylate, e.g. ethyl acrylate or butyl acrylate, together with an alkyl methacrylate, e.g. methyl methacrylate, in particular in identical molar proportions, their total amount preferably being from 70 to 95% by weight. In the acrylic/methacrylic combinations here, the proportion of the acrylate comonomer present is preferably from 15 to 65 mol %, and the proportion of the methacrylate comonomer present is preferably greater than that of the acrylate comonomer, generally by from 5 to 20 mol %. The proportion of the methacrylate present in the combination is preferably from 35 to 85 mol %.

In order to increase solvent resistance, suitable comonomers may be used for crosslinking, e.g. N-methylolacrylamide, N-methylolmethacrylamide, and the corresponding ether; epoxy materials, e.g. glycidyl acrylate, glycidyl methacrylate, and allyl glycidyl ether; monomers containing carboxy groups, e.g. crotonic acid, itaconic acid, or acrylic acid; anhydrides, e.g. maleic anhydride or itaconic anhydride; monomers containing hydroxy groups, e.g. allyl alcohols and hydroxyethyl or hydroxypropyl acrylate or the corresponding methacrylates; amides, such as acrylamide, methacrylamide, or maleimide, and isocyanates, e.g. vinyl isocyanate or allyl isocyanate. Among the abovementioned crosslinking comonomers, preference is given to N-methylolacrylamide and N-methylolmethacrylamide, and specifically and primarily because copolymer chains in which one of these monomers is present are capable of condensing with one another on exposure to elevated temperatures and thus giving the desired intermolecular crosslinking. However, the solvent resistance which may, if appropriate, be desired in the preferred acrylate coating can also be achieved via the presence of a foreign crosslinking agent, e.g. a melamine- or urea-formaldehyde condensate. If no solvent resistance is needed, crosslinking agents can be omitted.

The preferred acrylate coating can be applied to one or both sides of the film. However, it is also possible to provide only one side of the film with the inventive coating and to apply another coating to the opposite side. The coating formulation can comprise known additives, e.g. antistatic agents, wetting agents, surfactants, pH regulators, antioxidants, dyes, pigments, antiblocking agents, e.g. colloidal SiO₂, etc. It is normally advisable to incorporate a surfactant in order to increase the ability of the aqueous coating to wet the backing film comprised of polyester.

In another preferred embodiment of the invention, a water-soluble or hydrophilic coating is used to achieve improved adhesion to hydrophilic layers or printing inks. In particular, the preferred hydrophilic coating can be achieved in three ways; via:
1. a mixture comprised of an aromatic copolyester (I-1) having a water-dispersible functional group and a polyvinyl alcohol (II-1); or
2. a mixture comprised of an aromatic copolyester (I-2) having a water-dispersible functional group and a polyglycerol polyglycidyl ether (II-2); or
3. a mixture comprised of an aqueous polyurethane (I-3) and a polyvinyl alcohol (II-3).

The aromatic copolyesters (I-1 and I-2) are prepared from aromatic dicarboxylic acids, e.g. terephthalic acid, 2,6-naphthalenedicarboxylic acid or isophthalic acid, and from aliphatic diols which may, if appropriate, be branched diols or condensed diols, e.g. ethylene glycol, diethylene glycol, 2-methylpropanol, or 2,2-dimethylpropanol, and also from an ester-forming compound which bears a water-dispersible functional group. Examples of the functional groups are: hydroxy, carboxy, sulfonic acid groups, or phosphoric acid groups, or their salts. Preference is given to the salts of sulfonic acids and of carboxylic acids. The polyvinyl alcohol component (II-1 and II-3) used may comprise any polyvinyl alcohol which is water-soluble and can be prepared by normal polymerization methods. These polyvinyl alcohols are generally prepared via hydrolysis of polyvinyl acetates. The degree of hydrolysis should preferably be at least 70%, but more preferably from 80 to 99.9%. The polyglycerol polyglycidyl ethers (II-2) used preferably comprise reaction products of glycerol and epichlorohydrin having molecular weights of about 250-1200. The aqueous polyurethane (I-3) is prepared from a polyol, e.g. a polyester with glycol end groups, polyoxyetylene glycol, polyoxypropylene glycol, polyoxytetramethylene glycol, or acrylic polyols, and from a diisocyanate, e.g. xylene diisocyanate, hexamethylene diisocyanate, dicyclohexylmethane 4,4′-diisocyanate, toluidene diisocyanate, phenylene diisocyanate, diphenylmethane 4,4′-diisocyanate, or naphthalene 1,5-diisocyanate.

The preferred copolyester coatings, acrylate coatings, and hydrophilic coatings may moreover comprise other known additives, e.g. antistatic agents, wetting agents, surfactants, pH regulators, antioxidants, dyes, pigments, antiblocking agents, e.g. colloidal SiO₂, etc. (See, for example, EP-A-0 144 948, whose United States equivalent is U.S. Pat. No. 4,571,363, EP-A-0 144 878, whose United States equivalent is U.S. Pat. No. 4,493,872).

The inventive film has excellent suitability for packaging of food or drink (e.g. cheese, meat, etc.), for example. The film has excellent resistance to solvents, and also to water. By way of example, it has been found that two hours of extraction of the inventive film in steam at 121° C. give no measurable amounts of extract.

The total thickness of the inventive polyester film may vary within wide limits, and depends on the intended use. It is generally from 6 to 300 μm, preferably from 8 to 200 μm, particularly preferably from 10 to 100 μm, and if outer layers have been applied the proportion made up by the base layer (B) is preferably from 40 to 99% of the total thickness.

The present invention also provides a process for production of the film. To produce the film, the respective components (component I=polyester homo- or polyester copolymer, or a mixture thereof, component II=pelletized poly(m-xyleneadipamide) (MXD6)) are advantageously introduced directly into the extruder. The materials can be extruded at about 250-300° C. For reasons of process technology (thorough mixing of the various polymers) it has proven particularly advantageous here to extrude the mixture in a twin-screw extruder with one or more vents (but in a less preferred variant it has also been found possible to make successful use of a single-screw extruder).

The polymers for any outer layers (C and/or A) present are advantageously introduced into the (coextrusion) system by way of other extruders; here again, twin-screw extruders are in principle to be preferred over single-screw extruders. The melts are shaped in a coextrusion die to give flat melt films and mutually superposed in layers. The multilayer film is then drawn off and solidified with the aid of a chill roller and, if appropriate, other rollers.

According to the invention, the biaxial stretching process is carried out sequentially. It is preferable here to begin by stretching longitudinally (i.e. in machine direction MD) and then to stretch transversely (i.e. perpendicularly to the machine direction, TD). By way of example, the longitudinal stretching can be carried out with the aid of two rollers rotating at different speeds corresponding to the desired stretching ratio. For the transverse stretching process use is generally made of an appropriate tenter frame.

The temperature at which the biaxial stretching process is carried out can vary within a relatively wide range, and depends on the desired properties of the film.

According to the invention, the film is stretched longitudinally (MDO) in a temperature range from, preferably, 80 (heating temperatures 80-130° C., depending on the stretching ratio and on the stretching process used) to 130° C. (stretching temperatures 80-130° C., depending on the stretching ratio and on the stretching process used), and the transverse stretching process is carried out in a temperature range from, preferably, 90 (start of the stretching process) to 140° C. (end of the stretching process).

According to the invention, the longitudinal stretching ratio is greater than 3.0, and is preferably in the range from 3.1:1 to 5.0:1, preferably in the range from 3.2:1 to 4.9:1, and particularly preferably in the range from 3.3:1 to 4.8:1. According to the invention, the transverse stretching ratio is greater than 3.0, and is preferably in the range from 3.2:1 to 5.0:1, preferably in the range from 3.3:1 to 4.8:1, and particularly preferably in the range from 3.4:1 to 4.6:1.

The longitudinal orientation of the film may be carried out by standard methods, e.g. with the aid of two rollers rotating at different speeds corresponding to the desired stretching ratio. This is called single-gap stretching. In this stretching process, the film is heated to the stretching temperature on two or more preheat rollers arranged in series, and is stretched by the desired stretching ratio λ_{MD} (cf. FIG. 3) by means of two rollers running at different speeds. The temperature of the film during the orientation process is preferably in the range from 80 to 100° C., and depends on the material (mixing ratio of, by way of example, PET and MXD6) that is stretched, and on the stretching ratio λ_{MD}. The temperature of the film may be measured by means of IR, for example. Accordingly, the heating temperature is likewise preferably from 80 to 100° C., and in essence depends on the stretching temperature set. FIG. 3 shows the situation by way of example for an arrangement of 5 heating rollers (1-5) and of two stretching rollers (6-7). For a stretching temperature of 90° C., examples of the temperatures of the heating rollers are 70, 70, 80, 85, and 90° C.

The longitudinal orientation of the film is preferably carried out in a multistage process, particularly preferably in a two-stage process, e.g. with the aid of two or more rollers running at different speeds corresponding to the desired stretching ratio. In the case of the two-stage stretching process, the film is preferably oriented by the process published in EP-A-0 049 108, whose United States equivalent is U.S. Pat. No. 4,370,291 (cf. FIG. 4, which corresponds to FIG. 1 from EP-A-0 049 108). In this process, the film is heated to the stretching temperature on two or more preheat rollers arranged in series and is stretched by the desired stretching ratio λ_{MD} by means of two or more rollers running at different speeds (3 rollers being used for stretching in the two-stage stretching process according to FIG. 1 of EP-A-0 049 108) (cf. FIG. 4). According to the invention, the longitudinal stretching ratio λ_{MD} (where λ_{MD} corresponds to the overall stretching ratio λ₁·λ₂ of EP-A-0 049 108) is greater than 3.0 and is preferably in the range from 3.1:1 to 5.0:1, preferably in the range from 3.2:1 to 4.9:1, and particularly preferably in the range from 3.3:1 to 4.8:1. The temperature of the film during the orientation process is preferably in the range from 80 to 130° C., and depends on the material (mixing ratio of, for example, PET and MXD6) that is being stretched, and on the stretching ratio λ_{MD}. Accordingly, the heating temperature is likewise from 80 to 130° C., and depends in essence on the stretching temperature set. FIG. 4 shows the situation for an arrangement of 5 heating rollers (1-5) and of three stretching rollers (6-8). For a stretching temperature of 110° C., examples of the temperatures of the heating rollers are 70, 80, 85, 90, 105, 110, and 110° C.

According to the invention, and preferably prior to the transverse stretching process, at least one surface of the film may be in-line coated by the known processes. By way of example, the in-line coating can lead to improved adhesion between the metal layer or a printing ink and the film, to improvement of antistatic performance, or of processing performance, or else to further improvement of the barrier properties of the film.

In the heat-setting process which follows, the film is kept at a temperature of about 150-250° C. for a period of about 0.1-10 s. The film is then wound up conventionally.

The gloss of the two film surfaces is preferably greater than 80 when the angle of incidence is 20°. In one preferred embodiment, the gloss of the film surface is more than 100, and in one particularly preferred embodiment it is more than 120.

The haze of the film is preferably smaller than 20%. In one preferred embodiment, the haze of the film is less than 15%, and in one particularly preferred embodiment it is less than 10%. Low haze makes the film particularly suitable for the packaging application.

Another advantage of the invention is that the production costs of the inventive film are not substantially above those of a film comprised of standard polyesters. It has also been ensured that an amount that is preferably from 5 to 60% by weight, in particular from 10 to 50% by weight, in each case based on the total weight of the film, of cut material arising directly in the plant during film production can be used again in the form of regrind for film production, without any significant resultant adverse effect on the physical properties of the film.

The inventive film is particularly suitable for packaging of foods or of other consumable items. It also has excellent suitability for metallizing or vacuum-coating with ceramic substances. It features excellent barrier properties with respect to gases such as oxygen and CO₂.

The table below (Table 1) gives the most important inventive and preferred properties of the film.

TABLE 1

| | | | very | | |
|---|---|---|---|---|---|
| | | | particularly | | |
| | preferred | particularly | preferred | | |
| Film or base layer | range | preferred range | range | Unit | Test method |
| Component I (= thermoplastic polyester) | 55-95 | 60-95 | 65-95 | % by weight | |
| Component II (= poly(m-xyleneadipamide) | 5-45 | 5-40 | 5-35 | % by weight | |
| (MXD6) | | | | | |
| Melt viscosity of MXD6 used | <6000 | <5000 | <4000 | poise | in capillary |
| | | | | | rheometer, 280° C. |
| Biaxial orientation | sequential | + first MD, then | + MD, | | |
| | | TD | two-stage | | |
| Longitudinal stretching, stretching ratio λ_{MD} | 3.1:1-5.0:1 | 3.2:1-4.9:1 | 3.3:1-4.8:1 | | |
| Transverse stretching, stretching ratio λ_{TD} | 3.2:1-5.0:1 | 3.3:1-4.8:1 | 3.4:1-4.6:1 | | |
| Filler concentration | 0.02-1 | 0.04-0.8 | 0.06-0.6 | % by weight | |
| Film properties | | | | | |
| Transmission coefficient for oxygen | <45 | <40 | <30 | cm³/[12 μm]/ | DIN 53 380, |
| | | | | (m² · bar · d) | Part 3 |
| OTR of 12 μm thickness film | <45 | <40 | <30 | cm³/ | DIN 53 380, |
| | | | | (m² · bar · d) | Part 3 |
| Film thickness | 6-300 | 8-200 | 10-100 | μm | |
| Gloss of film | >80 | >100 | >120 | — | DIN 67 530 |
| (test angle = 20°) | | | | | |
| Haze of film | <20 | <15 | <10 | % | ASTM |
| | | | | | D1003-52 |
| Modulus of elasticity of film, | | | | | |
| in MD | >3500 | >4000 | >4500 | N/mm² | DIN 53 457 |
| in TD | >3500 | >4000 | >4500 | | |
| Ultimate tensile strength of film, | | | | | |
| in MD | >160 | >170 | >180 | N/mm² | DIN 53 455 |
| in TD | >200 | >210 | >220 | | |
| Contact angle with respect to water on | <64 | <62 | <60 | degree | see description |
| coated/treated side of film | | | | | |

Test Methods

The following methods were used to characterize the raw materials and the films:
(DIN=Deutsches Institut für Normung [German Institute for Standardization] ASTM=American Society for Testing and Materials)
   (1) Oxygen Transmission (OTR=Oxygen Transmission Rate)

The level of the oxygen barrier was measured using an OXTRAN® 100 from Mocon Modern Controls (USA) to DIN 53 380, Part 3 (23° C., 50% relative humidity, on both sides of the film). OTR was always measured here on film thickness 12 μm.

(2) Haze

Haze of the film was determined to ASTM D1003-52.

(3) SV (Standard Viscosity)

Standard viscosity SV (DCA) is measured in dichloroacetic acid by a method based on DIN 53726. Intrinsic viscosity (IV) is calculated from standard viscosity as follows:
IV(DCA)=6.907·10⁻⁴SV(DCA)+0.063096
(4) Gloss

Gloss was determined to DIN 67530. Reflectance was measured, this being an optical value characteristic of a film surface. Using a method based on the standards ASTM D523-78 and ISO 2813, the angle of incidence was set at 20° or 60°. A beam of light hits the flat test surface at the set angle of incidence and is reflected or scattered by the surface. A proportional electrical variable is displayed, representing light rays hitting the photoelectronic detector. The value measured is dimensionless and has to be stated together with the angle of incidence. The gloss test values given in the examples were measured at an angle of incidence of 20°.

(5) Roughness

Roughness Rₐ of the film was determined to DIN 4768 with a cut-off of 0.25 mm. This test was not carried out on a glass plate, but in a ring. In the ring method, the film is clamped into a ring so that neither of the two surfaces is in contact with a third surface (e.g. glass).

(6) Modulus of Elasticity

Modulus of elasticity is determined to DIN 53 457 or ASTM 882.

(7) Ultimate Tensile Strength, Tensile Strain at Break

Ultimate tensile strength and tensile strain at break are determined to DIN 53 455.

(8) Contact Angle with Water

Polarity of the surface was determined via measurement of the contact angle of distilled water on the coated or treated film surface. The measurement was made at 23° C. and 50% rel. humidity. A metering syringe is used to apply a droplet of width 1-2 mm of distilled water to the film surface. Since the measurement is time-dependent because of heat introduced by the illumination system (vaporization), charging, or droplet-spreading, the needle remains in the droplet so that during the measurement the droplet is carefully enlarged and then the contact angle is read off immediately through a goniometer eyepiece. (Measurement of advancing angle.) The average is calculated from 5 measurements. (cf. ASTM-D5946-01, for example).

(9) Coefficient of Friction

The coefficient of friction was determined using DIN 53375 or ASTM-D 1894.

### EXAMPLES

The following examples illustrate the invention. The products used (trade marks and producer) are in each case stated only once, and then also apply to the subsequent examples.

### Example 1

Chips comprised of polyethylene terephthalate (prepared by way of the transesterification process using Mn as transesterification catalyst, Mn concentration in polymer: 100 ppm; dried at a temperature of 150° C. to a residual moisture level below 100 ppm) and poly(m-xyleneadipamide) (MXD6), likewise dried at a temperature of 150° C., were introduced in a mixing ratio of 90:10 into the extruder (twin-screw extruder with two vents), and a single-layer film was extruded.

The film was oriented longitudinally (in two stages) and transversely, the product being a transparent film with total thickness 12 μm. Prior to wind-up, one side of the film was corona-treated, the intensity of treatment being 2 kW/m².

Film structure

| | |
|---|---|
| 10% by weight | poly(m-xyleneadipamide) (MXD6) from Mitsubishi Gas |
| | Chemical Co., product name NYLON ® MXD6 6007, |
| | with melt viscosity of 5000 poise |
| 80% by weight | polyethylene terephthalate 4023 from KoSa, Germany, |
| | with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | |
|---|---|---|
| Extrusion | Max. temperature | 280° C. |
| | Take-off roller temperature | 25° C. |
| Longitudinal | Longitudinal stretching ratio λ_{MDO} | 4.0 |
| stretching | λ₁ | 1.75 |
| | Stretching temperature | 115° C. |
| | during 1^{st} stretching process | |
| | λ₂ | 2.3 |
| | Stretching temperature | 113° C. |
| | during 2^{nd} stretching process | |
| | Heating temperature 1^{st} roller | 70° C. |
| | final roller | 115° C. |
| Transverse | Stretching temperature start | 110° C. |
| stretching | end | 134° C. |
| | Transverse stretching ratio | 3.8 |
| Setting | Temperature | 230° C. |
| | Duration | 3 s |

The surfaces of the film had the high gloss demanded, and the film had the low haze demanded, the low OTR demanded, and the high mechanical strength demanded. The film was moreover capable of very efficient production, i.e. without break-offs, and also exhibited the desired processing behavior (inter alia good winding quality, e.g. no blocking points, no longitudinal corrugations, no raised edges). The film had the desired improved adhesion, and the contact angle with respect to water was 63.7°.

### Example 2

Chips comprised of a copolyester comprised of terephthalate units and of isophthalate units, and of ethylene glycol units (the proportion of ethylene terephthalate being 90 mol % and the proportion of ethylene isophthalate being 10 mol %, prepared by way of the transesterification process using Mn as transesterification catalyst, Mn concentration in polymer: 100 ppm; dried at a temperature of 100° C. to a residual moisture level below 100 ppm) and poly(m-xyleneadipamide) MXD6, likewise dried at a temperature of 100° C., were introduced in a mixing ratio of 90:10 into the extruder (twin-screw extruder), and a single-layer film was extruded. The film was oriented longitudinally (in two stages) and transversely, the product being a transparent film with total thickness 12 μm.

The film was produced by a method similar to that of Example 1, but without corona treatment downstream of the biaxial stretching process. A latex with 4.5% by weight solids content, comprised of a copolymer comprised of 60% by weight of methyl methacrylate, 35% by weight of ethyl acrylate, and 5% by weight of N-methylolacrylamide, and of a surfactant, was applied to one side of the polyester film by the following process, as adhesion-promoter coating: the longitudinally stretched film was corona-treated (8 kW/m²), and then was coated with the latex described above via reverse-gravure coating on one side.

The biaxially stretched film was heat-set at 225° C. The dry weight of the coating was about 0.35 g/m², the coating thickness being about 0.025 μm.

Film structure

| | |
|---|---|
| 10% by weight | poly(m-xyleneadipamide) (MXD6) from Mitsubishi |
| | Gas Chemical Co., product name NYLON MXD6 |
| | 6007, with melt viscosity of 5000 poise |
| 80% by weight | polyester copolymer (ethylene terephthalate 90 mol %, |
| | ethylene isophthalate 10 mol %, KoSa, |
| | Germany) with SV 800 |
| 10% by weight | polyester from KoSa with SV 800, comprised of 99% |
| | by weight of polyester copolymer (ethylene |
| | terephthalate 90 mol %, ethylene isophthalate 10 mol % |
| | from KoSa), and 1.0% by weight of silica |
| | particles (SYLYSIA ® 320 from Fuji, Japan) with d₅₀ |
| | 2.5 μm. |

The production conditions in the individual steps of the process are as follows:

| | | |
|---|---|---|
| Extrusion | Max. temperature | 270° C. |
| | Take-off roller temperature | 25° C. |
| Longitudinal | Longitudinal stretching ratio λ_{MDO} | 4.2 |
| stretching | λ₁ | 1.83 |
| | Stretching temperature | 112° C. |
| | during 1^{st} stretching process | |
| | λ₂ | 2.3 |
| | Stretching temperature | 106° C. |
| | during 2^{nd} stretching process | |
| | Heating temperature 1^{st} roller | 70° C. |
| | final roller | 112° C. |
| Transverse | Stretching temperature start | 105° C. |
| stretching | end | 127° C. |
| | Transverse stretching ratio | 3.8 |
| Setting | Temperature | 225° C. |
| | Duration | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior (inter alia good winding quality, e.g. no blocking points, no longitudinal corrugations, no raised edges). The contact angle with respect to water was 63.8°. The reprographic adhesion of the film was checked, the result being good adhesion.

### Example 3

The mixing ratio of MXD6 and polyethylene terephthalate was changed from that of Example 1. In this example, chips comprised of polyethylene terephthalate and poly(m-xyleneadipamide) (MXD6, dried) were introduced in a mixing ratio of 85:15 into the extruder (twin-screw extruder), and a single-layer film was extruded. The film was oriented longitudinally (in two stages) and transversely, the product being a transparent film with total thickness 12 μm.

The method for production of the film was similar to that in Example 2. An aqueous dispersion with 6% by weight of copolyester, comprised of 95 mol % of isophthalate, 5 mol % of Na 5-sulfoisophthalate, and 100 mol % of ethylene glycol, and 0.56% by weight of colloidal SiO₂ was applied as coating to the polyester film by the following process:

One side of the longitudinally stretched film was coated with the copolyester dispersion described above via reverse-gravure coating.

The biaxially stretched film was heat-set at 230° C. The dry weight of the coating was about 0.30 g/m², the coating thickness being about 0.025 μm.

Film structure

| | |
|---|---|
| 15% by weight | poly(m-xyleneadipamide) (MXD6) from Mitsubishi |
| | Gas Chemical Co., product name NYLON MXD6 |
| | 6007, with melt viscosity of 5000 poise |
| 75% by weight | polyethylene terephthalate 4023 from KoSa, |
| | Germany, with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | |
|---|---|---|
| Extrusion | Max. temperature | 280° C. |
| | Take-off roller temperature | 25° C. |
| Longitudinal | Longitudinal stretching ratio λ_{MDO} | 3.8 |
| stretching | λ₁ | 1.65 |
| | Stretching temperature | 115° C. |
| | during 1^{st} stretching process | |
| | λ₂ | 2.3 |
| | Stretching temperature | 113° C. |
| | during 2^{nd} stretching process | |
| | Heating temperature 1^{st} roller | 70° C. |
| | final roller | 115° C. |
| Transverse | Stretching temperature start | 110° C. |
| stretching | end | 137° C. |
| | Transverse stretching ratio | 3.8 |
| Setting | Temperature | 230° C. |
| | Duration | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior, as in the preceding examples. The contact angle with respect to water was 57°.

Two specimens of the resultant single-side-coated film were introduced into a laboratory vacuum-coater, so as to metallize the coated side of one specimen and the uncoated side of the other. The vacuum chamber was evacuated to below 10 torr, and both the uncoated and the coated specimen were metallized with about 500 ANGSTROM of aluminum from a tungsten filament.

Within a period of 30 s after removal from the vacuum chamber, each specimen was checked for “metal abrasion”. To this end, the metal surface of each specimen studied was lightly rubbed with a cotton nonwoven, using the same number of strokes and approximately the same pressure. The “abrasion performance” of the coated side of the film was evaluated as good.

### Example 4

The mixing ratio of MXD6 and polyethylene terephthalate was changed from that of Example 1. In this example, chips comprised of polyethylene terephthalate and poly(m-xyleneadipamide) (MXD6, dried) were introduced in a mixing ratio of 75:25 into the extruder (twin-screw extruder), and a single-layer film was extruded. The film was oriented longitudinally (in two stages) and transversely, the product being a transparent film with total thickness 12 μm.

The method for production of the film was similar to that in Example 1, but without corona treatment downstream of the biaxial stretching process. An aqueous dispersion with 7% by weight solids content, comprised of 50% by weight of the aromatic copolyester A1 (copolyester containing 90 mol % of terephthalate, 10% of sodium 5-sulfoisophthalate, 80 mol % of ethylene glycol, and 20 mol % of diethylene glycol), 45% by weight of the water-dispersible polymer B2 (polyvinyl alcohol whose degree of hydrolysis was 88% and whose degree of polymerization was 1700), and 5% by weight of inert particles D1 (colloidal SiO₂ with particle diameter 0.05 μm) was applied as coating to the polyester film by the following process:

One side of the longitudinally stretched film coated with the copolyester dispersion described above via reverse-gravure coating. The dry weight of the coating was about 0.40 g/m², the coating thickness being about 0.05 μm.

Film structure

| | |
|---|---|
| 25% by weight | poly(m-xyleneadipamide) (MXD6) from Mitsubishi |
| | Gas Chemical Co., product name NYLON MXD6 |
| | 6007, with melt viscosity of 5000 poise |
| 65% by weight | polyethylene terephthalate 4023 from KoSa, |
| | Germany, with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | |
|---|---|---|
| Extrusion | Max. temperature | 280° C. |
| | Take-off roller temperature | 25° C. |
| Longitudinal | Longitudinal stretching ratio λ_{MDO} | 3.7 |
| stretching | λ₁ | 1.61 |
| | Stretching temperature | 118° C. |
| | during 1^{st} stretching process | |
| | λ₂ | 2.3 |
| | Stretching temperature | 115° C. |
| | during 2^{nd} stretching process | |
| | Heating temperature 1^{st} roller | 70° C. |
| | final roller | 118° C. |
| Transverse | Stretching temperature start | 110° C. |
| stretching | end | 139° C. |
| | Transverse stretching ratio | 3.8 |
| Setting | Temperature | 230° C. |
| | Duration | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior, as in the preceding examples.

The contact angle with respect to water was smaller than 50°.

In order to assess the adhesion-promoter action of the coating, an aqueous polyvinyl acetal solution (S-Lec KX-1, produced by Sekisui Chemical Co. Ltd., Japan, termed KX-1 below) was applied to the coated film and dried. The concentration of the coating solution was 8% by weight, and it was applied using a Baker-type applicator with layer thickness 127 nm. The coated film was immediately placed in an oven for 4 minutes at 100° C. for drying. An ink-jet printer (BJC-600J, Canon Inc.) was used to print a black square (area: 12×12 cm) onto the surface of the dried KX-1 coating, and the ink was dried in air at 50% relative humidity and 23° C., for 12 hours. An adhesive tape (Cello-tape, Nichiban Inc., width 18 mm) was applied to the printed area and rapidly peeled away. The extent to which the printed surface was removed by the adhesive tape was determined visually. The coated film exhibited good adhesion properties.

### Comparative Example

A film was produced corresponding to Example 1 of JP 2001 001 399. The roughness values for this film are too high, and the gloss of the film, and in particular the mechanical properties, are not within the inventive range. The wound-up roll also exhibits blocking points (points where there was blocking of the laps of film) due to absence of fillers within the film.

The properties and the structure of the films produced in the examples and in the comparative examples (CE) are given in Table 2.

TABLE 2

| | | | | | | | | | Ultimate | | Tensile | | | | |
|---|---|---|---|---|---|---|---|---|---|---|---|---|---|---|---|
| | | | | Proportion | | | Modulus of | | tensile | | strain | | | Roughness | |
| | | Film | | of | | Gloss | elasticity in | | strength | | at break | | OTR | of both | Coefficient of |
| | | thickness | Film | MXD6 in | Haze | of both | MDO | TDO | MDO | TDO | MDO | TDO | cm³/m² · | surfaces | friction of both |
| | | μm | structure | film % | % | surfaces | N/mm² | | N/mm² | | % | | bard | μm | surfaces % |
| Exam- | 1 | 12 | B | 10 | 5 | 130 | 4800 | 5200 | 170 | 220 | 100 | 80 | 40 | 70 | 0.42 |
| ples | 2 | 12 | B (IPA) | 10 | 4 | 140 | 4600 | 5000 | 160 | 200 | 120 | 90 | 42 | 60 | 0.46 |
| | 3 | 12 | B | 15 | 6 | 130 | 4900 | 5400 | 180 | 230 | 120 | 95 | 35 | 75 | 0.42 |
| | 4 | 12 | B | 25 | 7 | 130 | 4900 | 5500 | 190 | 230 | 120 | 95 | 15 | 75 | 0.4 |
| CE | 1 | 12 | B | 20 | 8 | 75 | 3300 | 3400 | 150 | 160 | 130 | 100 | 22 | 100 | >1 |

1. A biaxially oriented polyester film, comprising:
a) thermoplastic polyester and poly(m-xyleneadipamide) (MXD6), said film exhibiting
b) a modulus of elasticity of at least 3500 N/mm² in both orientation directions, and further comprising:
c) at least one adhesion-promoting surface.

2. The polyester film as claimed in claim 1, which further comprises fillers.

3. The polyester film as claimed in claim 1, which comprises from 5 to 45% by weight of poly(m-xyleneadipamide).

4. The polyester film as claimed in claim 1, wherein the melt viscosity of the poly(m-xyleneadipamide) is smaller than 6000 poise.

5. The polyester film as claimed in claim 2, which comprises from 0.02 to 1% by weight of said fillers.

6. The polyester film as claimed in claim 1, which comprises at least 55% by weight of thermoplastic polyester.

7. The polyester film as claimed in claim 1, wherein the thermoplastic polyester contains terephthalic acid units and/or isophthalic acid units and/or naphthalene-2,6-dicarboxylic acid units.

8. The polyester film as claimed in claim 1, wherein the thermoplastic polyester contains isophthalic acid units, terephthalic acid units, and ethylene glycol units.

9. The polyester film as claimed in claim 1, wherein the thermoplastic polyester used comprises polyethylene terephthalate.

10. The polyester film as claimed in claim 1, said film comprising a base layer (B) and of one or two outer layers (A) and (C), where the outer layers (A) and (C) may be identical or different.

11. The polyester film as claimed in claim 10, wherein the outer layers (A) and/or (C) comprise the thermoplastic polyester used for the base layer (B).

12. The polyester film as claimed in claim 10, wherein the polymer used for the outer layers (A) and/or (C) comprises polyethylene terephthalate or a polyester copolymer which contains isophthalic acid units, terephthalic acid units, and ethylene glycol units.

13. The polyester film as claimed in claim 1, wherein the adhesion-promoting surface is produced via corona or flame treatment, and/or via an adhesion-promoting coating.

14. The polyester film as claimed in claim 1, wherein the adhesion-promoting surface is an adhesion-promoting coating.

15. The polyester film as claimed in claim 14, wherein the adhesion-promoting coating is a copolyester coating or an acrylate coating.

16. The polyester film as claimed in claim 1, wherein the adhesion-promoting film surface has a contact angle smaller than 64° with water.

17. The polyester film as claimed in claim 1, said film exhibiting a gloss greater than 80.

18. The polyester film as claimed in claim 1, wherein film having a thickness of 12 μm, exhibits an oxygen transmission (OTR) smaller than 45 cm³·m⁻²·d⁻¹·bar⁻¹.

19. The polyester film as claimed in claim 1, said film exhibiting a haze smaller than 20%.

20. The polyester film as claimed in claim 1, wherein said film is produced with a sequential stretching process.

21. A process for production of a polyester film as claimed in claim 1, said process comprising the steps of
a) extruding or coextruding the film,
b) sequentially stretching the extruded film,
c) producing an adhesion-promoting surface, and
d) heat-setting the stretched film.

22. The process as claimed in claim 21, wherein the sequential stretching comprises first orienting the film in the machine direction and then orienting the film in the transverse direction.

23. The process as claimed in claim 22, wherein the orienting in the machine direction takes place in 2 stages.

24. The process as claimed in claim 21, wherein the adhesion-promoting surface is produced via corona or flame treatment, and/or via an adhesion-promoting coating.

25. Packaging material comprising a polyester film as claimed in claim 1.

26. Packaging material as claimed in claim 25, wherein said packaging is food packaging or consumable item packaging.
